(19) United States
(12) Patent Application Publication
(10) Pub. No.: US 2026/0120259 A1
(43) Pub. Date: Apr. 30, 2026

(54) DYNAMIC TUNING OF METADATA FOR DISPLAY MAPPING

(71) Applicant: DOLBY LABORATORIES LICENSING CORPORATION

(72) Inventors: Ali ZANDIFAR, Los Angeles, CA (US); Samuel Hebert BILODEAU, Concord, CA (US)

(73) Assignee: DOLBY LABORATORIES LICENSING CORPORATION, (US)

(21) Appl. No.: 19/480,442

(22) PCT Filed: Apr. 23, 2024
(86) PCT No.: PCT/US2024/025857

§ 371 Date: Oct. 31, 2025

Related U.S. Application Data
(60) Provisional application No. 63/499,639, filed on May 2, 2023.

(30) Foreign Application Priority Data
Jun. 1, 2023 (EP) 23176663.5

(51) Int. Cl. G06T 5/92; G06T 5/20; G06T 5/50; G06V 10/44; G06V 10/56; G06V 10/764

(52) U.S. Cl. CPC G06T 5/92; G06T 5/20; G06T 5/50; G06V 10/457; G06V 10/56; G06V 10/764; G06T 2207/20208; G06V 2201/10

(57) ABSTRACT

Methods and apparatus for tuning metadata for more-optimal display mapping. According to an example embodiment, a method of tuning metadata includes generating a grayscale image via box filtering applied to an input HDR color image. The method also includes generating a first binary mask via intensity thresholding of the grayscale image and generating a second binary mask based on connected component analysis of the first binary mask. The method further includes generating a set of L1 metadata based on a pixelwise product of the grayscale image and the second binary mask and generating an SDR color image by display mapping the HDR color image with the generated set of L1 metadata.

### 1. CROSS-REFERENCE TO RELATED APPLICATIONS

This application claims the benefit of priority from U.S. Provisional Patent Application Ser. No. 63/499,639, filed on 2 May, 2023, and EP Patent Application No. EP 23176663.5, filed on 1 Jun. 2023, each of which is incorporated by reference herein in its entirety.

### 2. FIELD OF THE DISCLOSURE

Various example embodiments relate to image-processing operations and, more specifically but not exclusively, to determining parameters for display mapping of images and video streams.

### 3. BACKGROUND

Herein, the term “metadata” relates to auxiliary information that is transmitted as part of the coded bitstream and assists a decoder in rendering the corresponding image(s). For television broadcasting and video streaming, video metadata may be used to provide side information about specific video and audio streams or files. Metadata can either be embedded directly into the video or be included as a separate file within a container, such as the MP4 or MKV. Metadata may include information about the entire video stream or file or about specific video frames. Created by cameras, encoders, and other video-processing elements, metadata may include but are not limited to timestamps, video resolution, digital film-grain parameters, color space or gamut information, reference display parameters, master display parameters, auxiliary signal parameters, file size, closed captioning, audio languages, ad-insertion points, color spaces, error messages, and so on.

### BRIEF SUMMARY OF SOME SPECIFIC EMBODIMENTS

Disclosed herein are various embodiments of methods and apparatus for dynamic tuning of metadata for display mapping. Various examples provide techniques for automatically adjusting level 1 (L1) metadata for a display-mapped standard-dynamic-range (SDR) color image based on spatial analysis of a corresponding high-dynamic-range (HDR) color image. In some embodiments, the L1 metadata are adjusted based on box filtering of the HDR color image with at least two differently sized kernels; a binary mask created via intensity thresholding of a grayscale image corresponding to the HDR color image; and connected-component analysis of the binary mask. In some examples, dilation and pruning are used in the process of generating the binary mask. Various example embodiments can beneficially provide a more-optimal selection of L1-max and/or L1-min values to balance image brightening and/or source contrast retention with perceivable highlight detail retention in the SDR image.

According to an example embodiment, provided is an image-processing apparatus for estimating metadata, the apparatus comprising: at least one processor; and at least one memory including program code, wherein the at least one memory and the program code are configured to, with the at least one processor, cause the apparatus at least to: generate a grayscale image via first filtering applied to an input color image having a first dynamic range (DR), the first filtering being performed with a first kernel; generate a first binary mask based on intensity thresholding applied to the grayscale image; generate a second binary mask based on connected component analysis of the first binary mask; and generate a first set of L1 metadata based on a pixelwise product of the grayscale image and the second binary mask.

According to another example embodiment, provided is a method of tuning metadata, the method comprising: generating a grayscale image via first filtering applied to an input color image having a first DR, the first filtering being performed with a first kernel; generating a first binary mask based on intensity thresholding applied to the grayscale image; generating a second binary mask based on connected component analysis of the first binary mask; and generating a first set of L1 metadata based on a pixelwise product of the grayscale image and the second binary mask.

According to yet another example embodiment, provided is a non-transitory computer-readable medium storing instructions that, when executed by an electronic processor, cause the electronic processor to perform operations comprising the above method.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram depicting an example process for a video/image delivery pipeline.

FIG. 2 is a flowchart illustrating a display-mapping method according to some embodiments.

FIG. 3 is a flowchart illustrating a display-mapping method according to some additional embodiments.

FIG. 4 is a block diagram illustrating a computing device according to various examples.

### DETAILED DESCRIPTION

As used herein, the term “dynamic range” (DR) may relate to a capability of the human visual system (HVS) to perceive a range of intensity (e.g., luminance, luma) in an image, e.g., from darkest blacks (darks) to brightest whites (highlights). In this sense, DR relates to a “scene-referred” intensity. DR may also relate to the ability of a display device to render, adequately or approximately, an intensity range of a particular breadth. In this sense, DR relates to a “display-referred” intensity. Unless a particular sense is explicitly specified to have particular significance at any point in the description herein, it should be inferred that the term may be used in either sense, e.g., interchangeably.

As used herein, the term “high dynamic range” (HDR) relates to a DR breadth that spans 14-15 or more orders of magnitude of the HVS. In practice, the DR over which a human may simultaneously perceive an extensive breadth in intensity range may be somewhat truncated, in relation to HDR. As used herein, the terms “enhanced dynamic range” (EDR) or “visual dynamic range” (VDR) may individually or interchangeably relate to the DR that is perceivable within a scene or image by a human visual system that includes eye movements, allowing for some light adaptation changes across the scene or image. Herein, EDR may relate to a DR that spans 5 to 6 orders of magnitude. While perhaps somewhat narrower in relation to the true scene-referred HDR, EDR nonetheless represents a wide DR breadth and sometimes may also be referred to as HDR.

In practice, images comprise one or more color components (e.g., luma Y and chroma Cb and Cr) of a color space, where each color component is represented with a precision of n-bits per pixel (e.g., n=8). Using non-linear luminance coding (e.g., gamma encoding), images where n≤8 (e.g., 24-bit color JPEG images) are considered images of standard dynamic range (SDR), while images where n>8 may be considered images of EDR.

A reference electro-optical transfer function (EOTF) for a given display characterizes the relationship between color values (e.g., luminance) of an input video signal to output screen color values (e.g., screen luminance) produced by the display. For example, ITU Rec. ITU-R BT. 1886, “Reference electro-optical transfer function for flat panel displays used in HDTV studio production,” (March 2011), which is incorporated herein by reference in its entirety, defines the reference EOTF for flat panel displays. Given a video stream, information about its EOTF may be embedded in the bitstream as (image) metadata.

As used herein, the term “PQ” refers to perceptual luminance amplitude quantization. The HVS responds to increasing light levels in a very nonlinear way. A human's ability to see a stimulus is affected by the luminance of that stimulus, the size of the stimulus, the spatial frequencies making up the stimulus, and the luminance level that the eyes have adapted to at the particular moment one is viewing the stimulus. In some cases, a PQ function may map linear input gray levels to output gray levels that better match the contrast sensitivity thresholds in the human visual system. An example PQ mapping function is described in SMPTE ST 2084:2014 “High Dynamic Range EOTF of Mastering Reference Displays” (hereinafter “SMPTE”), which is incorporated herein by reference in its entirety.

Many consumer displays may support luminance of 100 to 300 cd/m² or nits. Many consumer HDTVs range from 300 to 500 nits, with new models reaching approximately 1000 nits. Such conventional displays typify lower dynamic range (LDR) displays, some of which are referred to as SDR displays. Legacy SDR video is a video technology that represents light intensity based on the brightness, contrast, and color characteristics and limitations of a cathode ray tube (CRT) display. Legacy SDR video typically represents image colors with a maximum luminance of around 100 nits, a black level of around 0.1 nits, and the ITU 709/sRGB color gamut.

The following description provides nonlimiting examples of metadata that can be used in various embodiments disclosed herein. In some examples, the metadata can be sorted into several distinct sets, often referred as metadata levels. Various embodiments may rely on all or only some of the metadata levels. In other words, in some examples, additional metadata may be generated and added to the image stream after the image processing disclosed herein is completed or previously available metadata (if any) may be combined with the newly generated metadata. Additional examples of metadata that can be used in at least some embodiments are described in U.S. Pat. Nos. 9,961,237, 10,540,920, and 10,600,166, all of which are incorporated herein by reference in their entirety.

Level 1 or L1 is a first set of metadata that may be created by performing a pixel-level, analysis of an image. L1 metadata include the following values: (i) the lowest black level in the image, denoted Minimum (or min); (ii) the average luminance level across the image, denoted Average (or avg, or mid); and (iii) the highest luminance level in the image, denoted Maximum (or max). L1 metadata are usually created per image and may be assumed to be unique for every image (e.g., video frame) on the timeline or in a piece of content, such as a movie, an episode of a television series, or a documentary. However, in some examples, a plurality of images may have the same metadata, e.g., when a colorist copies the L1 metadata from one image to one or more other images on the timeline. The copying is sometimes done to match and apply the same mapping to similar shots of a scene. Additional scenarios exist, in which a plurality of images has the same metadata. Such scenarios are known to persons of ordinary skill in the pertinent art.

In some examples, an L1-min value denotes the minimum of the PQ-encoded min(RGB) values of the respective portion of the video content (e.g. a video frame or image), while taking into consideration only an active area (e.g., by excluding gray or black bars, letterbox bars, and the like), where min(RGB) denotes the minimum of color component values {R, G, B} of a pixel. The L1-mid and L1-max values are also computed in a similar fashion. In a specific example, L1-mid may denote the average of the PQ-encoded max(RGB) values of the image, and L1-max may denote the maximum of the PQ-encoded max(RGB) values of the image, where max(RGB) denotes the maximum of color component values {R, G, B} of a pixel. In some embodiments, L1 metadata may be normalized to be in the range [0, 1].

In some examples, when there is a need to create a dynamic or animated trim within a shot due to a transition in the grade or the light/color composition of the shot, the metadata are generated per frame to create a smooth transition from one state of the image to the other. In such examples, the per-frame metadata on each frame of the animation or dynamic may include L1 metadata as well as Level 2 (L2), Level 3 (L3), and/or Level 8 (L8) metadata, often referred to as trims, depending on the trim parameters that are being changed across the range of frames. A trim pass offers the colorist an option to check the mapping resulting from the L1 metadata and make changes or adjustments to obtain a different result that matches the creative intent. In some examples, changes to the metadata can be made using a set of trim controls provided on the color correction or mastering system. In various examples, the trim controls produce corrected metadata and/or new metadata that modify the mapping, and the colorist can use any combination of available controls to produce a desired result. While the trim controls are typically designed to mimic the look and feel of color correction tools/controls that colorists are familiar with, it is important to note that trim controls are substantially metadata-modifier controls that do not typically perform any color correction or alter the HDR Master grade. Adjustments to the trim controls typically produce new metadata, resulting in a change in the mapping that is observed on the output (e.g., target) display. The new metadata can be exported, e.g., as an XML file.

In some examples, some or all of the following controls are used to generate various trim levels of metadata. Lift, Gamma, and Gain are trim controls used to modify the shadows, mid-tones, and highlights of the image. In operation, these three controls are substantially adjusting the tone-mapping curve while mimicking the response of conventional (not metadata based) lift, gamma, and gain controls. In other words, the Lift, Gamma, and Gain trim controls only mimic the effect of, but have a different function compared to that of the conventional lift, gamma, and gain controls. Tone Detail is a trim control that restores sharpness in the highlight areas of the mapped image. Tone Detail works well in SDR by restoring some of the sharpness and details in the highlights that may be lost when mapping down from HDR to SDR. Chroma Weight is a trim control that helps preserve color saturation in the upper mid-tones and highlight areas, especially when mapping down from HDR to SDR. This trim control is typically used to reduce luminance in highly saturated colors, thereby adding detail in those areas. Chroma Weight ranges from minimum luminance with maximum saturation on one end to maximum luminance with minimum saturation on the other end of the control range. Saturation Gain is a trim control that enables colorists to adjust the overall saturation of the mapped image. Saturation Gain typically affects all colors in the image.

In some examples, some or all of the following additional trim controls are used. Mid-Tone Offset is a useful trim control for matching the overall exposure of the mapped SDR signal to the HDR master or to an SDR reference. Mid-Tone Offset acts as an offset to the L1 mid values and adjusts the image's mid-tones without affecting the blacks and highlights. The changes made using Mid-Tone Offset are recorded as part of L3 metadata for each shot or frame of the project. Mid Contrast Bias is a trim control that compresses or stretches the image around the mid-tone region and can increase or decrease contrast in the mid-tones of the mapped image. Mid Contrast Bias is typically used along with Lift and/or Gain to produce desired overall results. Highlight Clipping is a trim control that allows the colorist to set the level of detail in the highlights by either retaining or clipping them as required. Clipping the highlights may be used, e.g., when the mapped image displays details that are undesirable. The resulting clipping may extend into the upper mid tones and may trigger some compensation using Gamma or Gain adjustments. Highlight Clipping can be useful, e.g., when trying to match the mapped SDR to an existing SDR reference (e.g., as described in reference to some examples below).

In some examples, further trim controls, referred to as secondary trim controls, are recorded using L8 metadata for each shot or frame of the project. For example, Color Saturation trim controls allow colorists to adjust the saturation of the mapped image individually across red, yellow, green, cyan, blue, and magenta, or all colors collectively when linked together. Color Hue trim controls allow colorists to offset the hue of the mapped image individually across red, yellow, green, cyan, blue, and magenta. These controls are useful when trying to fit/shift a larger color gamut into a smaller color gamut. Adjustments made to the mapping using the secondary trim controls are typically recorded as L8 metadata in the XML file.

Tone mapping is a technique used in image processing and computer graphics to map one set of colors to another to approximate the appearance of HDR images in a medium that has a more-limited dynamic range. For example, printouts, LCD monitors, and projectors have respective limited dynamic ranges that are typically insufficient to reproduce the full range of light intensities present in natural scenes. Tone mapping addresses the problem of strong contrast reduction from the scene radiance to the displayable range while preserving the image details and color appearance important to the original scene content.

Some of the goals of tone mapping can be stated differently, depending on the application. For some applications, producing aesthetically pleasing images is emphasized. Some other applications emphasize reproducing as many image details as possible or maximizing the image contrast. In realistic rendering applications, tone mapping may be directed at obtaining a perceptual match between a real scene and a displayed image even though the display device is not able to reproduce the full range of luminance values.

In some examples, tone mapping is directed at reproducing a given scene or image on a display device such that the brightness sensation of the image to a human viewer closely matches the real-world brightness sensation. However, a perfect solution to this problem is typically not found and, thus, the output image on a display is often generated based on a tradeoff between different desired image features. Given appropriate metrics for the intended application, one possible solution is to treat the tone mapping as an optimization problem. For example, the values of L1-min, L1-mid, and/or L1-max can be selected, e.g., as described in more detail below, to optimize the tone mapping for the given display device, image, and/or application.

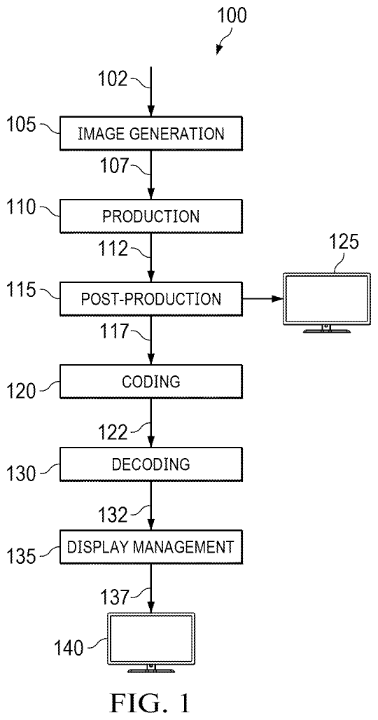

FIG. 1 depicts an example process of a video delivery pipeline (100), showing various stages from video/image capture to video/image-content display according to an embodiment. A sequence of video/image frames (102) may be captured or generated using an image-generation block (105). The frames (102) may be digitally captured (e.g., by a digital camera) or generated by a computer (e.g., using computer animation) to provide video and/or image data (107). Alternatively, the frames (102) may be captured on film by a film camera. Then, the film may be translated into a digital format to provide the video/image data (107). In some examples, the image-generation block (105) includes generating an MPI image or video.

In a production phase (110), the data (107) may be edited to provide a video/image production stream (112). The data of the video/image production stream (112) may be provided to a processor (or one or more processors, such as a central processing unit, CPU) at a post-production block (115) for post-production editing. The post-production editing of the block (115) may include, e.g., adjusting or modifying colors or brightness in particular areas of an image to enhance the image quality or achieve a particular appearance for the image in accordance with the video creator's creative intent. This part of post-production editing is sometimes referred to as “color timing” or “color grading.” Other editing (e.g., scene selection and sequencing, image cropping, addition of computer-generated visual special effects, removal of artifacts, etc.) may be performed at the block (115) to yield a “final” version (117) of the production for distribution. In some examples, operations performed at the block (115) include enhancing texture and/or alpha channels in multiplane images/video. During the post-production editing (115), video and/or images may be viewed on a reference display (125).

Following the post-production (115), the data of the final version (117) may be delivered to a coding block (120) for being further delivered downstream to decoding and playback devices, such as television sets, set-top boxes, movie theaters, and the like. In some embodiments, the coding block (120) may include audio and video encoders, such as those defined by the ATSC, DVB, DVD, Blu-Ray, and other delivery formats, to generate a coded bitstream (122). In a receiver, the coded bitstream (122) is decoded by a decoding unit (130) to generate a corresponding decoded signal (132) representing a copy or a close approximation of the signal (117). The receiver may be attached to a target display (140) that may have somewhat or completely different characteristics than the reference display (125). In such cases, a display management (DM) block (135) may be used to map the decoded signal (132) to the characteristics of the target display (140) by generating a display-mapped signal (137). Depending on the embodiment, the decoding unit (130) and the DM block (135) may include individual processors or may be based on a single integrated processing unit.

For some images, conventional mapping performed in the DM block (135) may cause the image to be heavily darkened to allow the details in the highlights of the mapped image to remain perceptible at the cost of diminished perceptibility in other parts of the image due to a non-optimal selection of L1-max. For some other images, conventional mapping performed in the DM block (135) may cause some otherwise perceptible details to be lost in the lowlights (e.g., shadow regions) of the mapped image due to a non-optimal selection of L1-min. Various embodiments disclosed herein are directed at providing a more-optimal selection of L1-max and/or L1-min levels to balance image brightening and/or source contrast retention with perceivable highlight detail retention. For example, a proposed metadata tuning algorithm may operate to dynamically adjust the corresponding L1-max values based on the distribution of highlight regions in the image. Some embodiments of the metadata tuning algorithm rely on morphological dilation and connected component (CC) analysis, as described in more detail below.

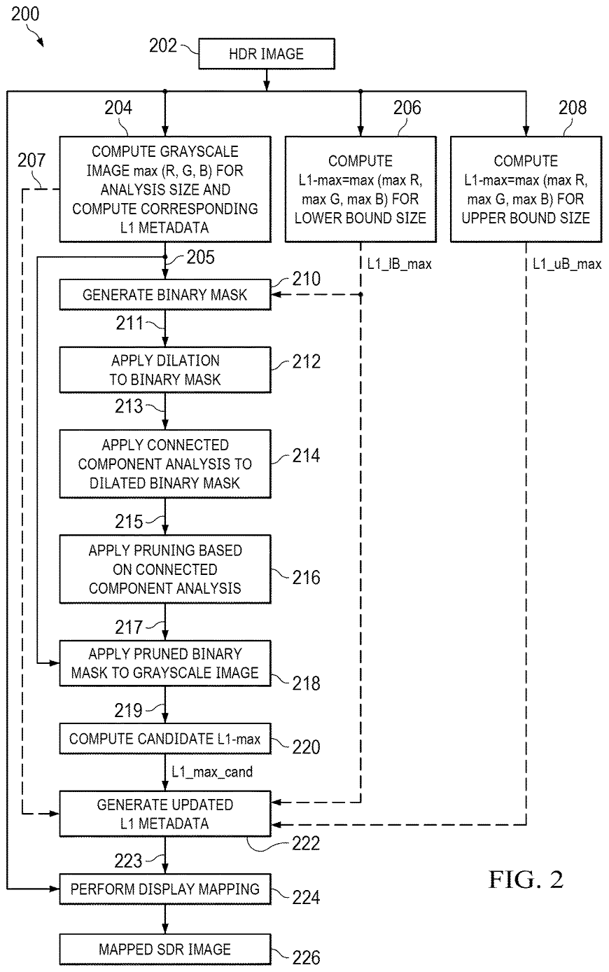

FIG. 2 is a flowchart illustrating a display-mapping method (200) according to some embodiments. In operation, the method (200) is used to perform a more-optimal selection of L1-max and then generate a display-mapped SDR image (226) based on an input HDR image (202) and the updated L1 metadata. The display-mapped SDR image (226) can then be used, e.g., to generate the display-mapped signal (137) for the target display (140). For illustration purposes and without any implied limitations, operations of the method (200) are described in reference to an example total image size of 1920×1080 pixels² and the RGB color system. From the provided description, a person of ordinary skill in the pertinent art will be able to apply the method (200) to other total image sizes and/or other color systems, without any undue experimentation.

In some examples, the method (200) uses the following configuration parameters:
(i) Lower bound size. This parameter is used, e.g., in operations of an image filtering block (206). A nonlimiting example value of the lower bound size is 32x18 pixels²
(ii) Upper bound size. This parameter is used, e.g., in operations of an image filtering block (208). A nonlimiting example value of the upper bound size is 128×64 pixels². As the name implies, the upper bound size is larger than the lower bound size.
(iii) Analysis size. This parameter is used, e.g., in operations of an image filtering block (204). A nonlimiting example value of the analysis size is 960×540 pixels².
(iv) Pruning threshold. This parameter is used, e.g., in operations of a pruning block (216). A nonlimiting example value of the pruning threshold is 6 pixels.
(v) Clamping, “yes” or “no.” This parameter can be used, e.g., in reference to the clamping operations of a block (222).
(vi) Dilation shape and size. This parameter is used, e.g., in operations of a dilation block (212). A nonlimiting example of the dilation structural element is a square having a size of 2×2 pixels².

Each of the filtering blocks (204, 206, 208) of the method (200) includes a respective set of filtering operations with a respective kernel. In various examples, the kernel is a square matrix, wherein each matrix element is 1, i.e., the corresponding filtering is box filtering. The kernel size k₁ used in the filtering block (204) is determined based on Eq. (1):

$${k}_{1} = \frac{max ( ImgSz )}{max ( AnSz )} \qquad ( 1 )$$

where ImgSz is the larger dimension (e.g., width or height) of the input HDR image (202); and AnSz is the larger dimension of the analysis size (which is specified as one of the configuration parameters described above). For the above-mentioned non-limiting example, k₁=1920/960=2, and the kernel is a 2×2 matrix. The kernel size k₂ used in the filtering block (206) is determined based on Eq. (2):

$${k}_{2} = \frac{max ( ImgSz )}{max ( LBSz )} \qquad ( 2 )$$

where LBSz is the larger dimension of the lower bound size (which is specified in the configuration parameters). For the above-mentioned non-limiting example, k₂=1920/32=60, and the kernel is a 60×60 matrix. The kernel size k₃ used in the filtering block (208) is determined based on Eq. (3):

$${k}_{3} = \frac{max ( ImgSz )}{max ( UBSz )} \qquad ( 3 )$$

where UBSz is the larger dimension of the upper bound size (which is specified in the configuration parameters). For the above-mentioned non-limiting example, k₃=1920/128=15, and the kernel is a 15×15 matrix.

After the filtering operations with the above-described kernels in the filtering blocks (204, 206, 208), the following additional operations are applied to the respective filtered images produced in those filtering blocks. The filtering block (204) includes converting the filtered RGB color image into a corresponding grayscale image (205) by determining, for each pixel, the value of max(R, G, B) and assigning the determined value to the corresponding pixel of the grayscale image (205) as the luma value thereof. In other words, the pixel luma value of the grayscale image (205) produced in the block (204) is the maximum value of the R, G, and B channels of that pixel in the filtered RGB color image.

The filtering block (204) also includes computing the L1-max, L1-mid, and L1-min values (207) for the filtered RGB color image and/or the grayscale image (205). The filtering block (206) includes computing the L1-max value for the lower bound filtered image. The filtering block (208) similarly includes computing the L1-max value for the upper bound filtered image. For each of the blocks (204, 206, 208), the computation of L1-max is performed using Eq. (4):

$$L 1 max = max ( max R , max G , max B ) \qquad ( 4 )$$

Hereafter, the L1-max value computed in the block (206) is denoted as L1_lb_max, and the L1-max value computed in the block (208) is denoted as L1_ub_max. The L1-max, L1-mid, and L1-min values for the filtered RGB color image are denoted as L1_analysis_max, L1_analysis_mid, and L1_analysis_min, respectively.

Operations of a next block (210) of the method (200) include converting the grayscale image (205) generated in the block (204) into a corresponding binary mask (211) based on the value of L1_lb_max computed in the block (206). More specifically, each pixel of the binary mask (206) can only have a value of 0 or 1. The pixel value in the binary mask (211) is “1” when the corresponding pixel in the grayscale image (205) has a value that is equal to or greater than L1_lb_max. The pixel value in the binary mask (211) is “0” when the corresponding pixel in the grayscale image (205) has a value that is smaller than L1_lb_max.

The method (200) further includes applying dilation to the binary mask (211) in the dilation block (212) to produce a dilated binary mask (213). Herein, dilation is a morphological operation that adds pixels to the boundaries of objects in an image. The number of added pixels depends on the size and shape of the dilation structuring element used to process the image that is being dilated. In the morphological dilation operations, the state of any given pixel in the output image is determined by applying a dilation rule to the corresponding pixel and its neighbors in the input image. In a binary image, a pixel is set to “1” if any of the neighboring pixels within the structural element have the value of “1.” As already indicated above, the dilation structural element used in the dilation operations of the block (212) is a configuration parameter of the method (200). In various examples, morphological dilation makes some objects more visible and can fill in small holes in some other objects. For example, thin lines appear thicker, and filled shapes appear larger after morphological dilation.

The method (200) further includes applying connected component (CC) analysis to the dilated binary mask (213) in a block (214). Connected-component labeling (CCL), connected-component analysis (CCA), blob extraction, region labeling, blob discovery, or region extraction is an algorithmic application of graph theory, where subsets of connected components are uniquely labeled based on a given heuristic. CC labeling is not to be confused with segmentation. CC labeling is used to detect connected regions in binary digital images, such as the dilated binary mask of the dilation block (212). A brief overview of the process is as follows. A graph, containing vertices and connecting edges, is constructed from relevant input data. The vertices contain information used by the comparison heuristic, while the edges indicate connected neighbors. A suitable algorithm traverses the graph, labeling the vertices based on the connectivity and relative values of their neighbors. Connectivity is determined by the medium. For example, image graphs can be 4-connected neighborhood or 8-connected neighborhood. Following the labeling stage, the graph may be partitioned into subsets, after which the original information can be recovered and processed.

Herein, the term “connected components labeling” or “CCL” refers to the creation of a labeled image in which the positions associated with the same connected component of the binary input image have a unique label. The CCL input is a binary image. The CCL output is a symbolic image in which the label assigned to each pixel is an integer uniquely identifying the connected component to which that pixel belongs. CCA includes CCL of white or black pixels followed by property measurement of the component regions and decision making.

An example output of the operations performed in the block (214) is a labeled binary mask (215), wherein different labels identify different distinct subsets of components determined using the above-indicated CCL and CCA processes. One characteristic of each distinct subset in the labeled binary mask (215) is a subset size, e.g., defined as the number of pixels in the subset. Depending on the input HDR image (202), the topologies of different distinct subsets in the labeled binary mask (215) may vary. For example, in some instances, a subset may be shaped as a contiguous island. In some other instances, a subset may be similar to a collection (archipelago) of variously shaped islands having no “land” connections therebetween.

Operations of the pruning block (216) include removing relatively small distinct subsets from the labeled binary mask (215). The sizes of the different distinct subsets of the labeled binary mask (215) are known from the CCA of the block (214). As already indicated above, the pruning threshold is a configuration parameter of the method (200). The distinct subsets whose size is smaller than the pruning threshold are removed from the labeled binary mask (215) in the pruning block (216) to produce a corresponding pruned binary mask (217). In some examples, the pruned binary mask (217) retains the CCA-based subset labeling for the remaining subsets.

The method (200) further includes applying the pruned binary mask (217) to the grayscale image (205) in a block (218). In a representative example, an output of the block (218) is a masked greyscale image (219) generated by pixelwise multiplication of the grayscale image (205) and the pruned binary mask (217). Such multiplication nulls the pixel values outside the above-described subsets of the pruned binary mask (217) while the pixels inside the subsets remain the same as in the grayscale image (205).

The method (200) further includes computing a candidate L1-max value based on the masked greyscale image (219) in a block (220). Hereafter, the computed candidate L1-max value is denoted as L1_max_cand. In a representative example, the value of L1_max_cand is computed as follows:

$$L1max\_cand = {max}_{j} ( median {\{ P \}}_{j} ) \qquad ( 5 )$$

where j is the index used to label different distinct subsets in the pruned binary mask (217); and {P}ⱼ denotes the set of pixel values in the masked greyscale image (219) corresponding to the j-th subset. In other words, computations in accordance with Eq. (5) include finding a median pixel value for each of the distinct subsets in the masked greyscale image (219) and then finding a maximum value among those median pixel values.

The method (200) further includes generating an updated set (223) of L1 metadata in a block (222). Herein, the updated L1-max, L1-mid, and L1-min values are denoted as L1_max_upd, L1_mid_upd, and L1_min_upd, respectively, and are determined as follows:

$$L1\_max \_upd = clamp ( L1\_lb \_max , L1\_max \_cand , L1\_ub \_max ) \qquad ( 6 )$$

$$L1\_mid \_upd = L1\_analysis \_mid \qquad ( 7 )$$

$$L1\_min \_upd = L1\_analysis \_min \qquad ( 8 )$$

The clamping function of Eq. (6) ensures that the value of L1_max_upd is between the values L1_lb_max and L1_ub_max computed in the blocks (206, 208). Eqs. (7)-(8) set the updated L1-mid and L1-min values to be the same as those of the grayscale image (205).

The display-mapped SDR image (226) is generated in a display mapping block (224) of the method (200). Operations of the display mapping block (224) include applying the updated set (223) of L1 metadata to the input HDR image (202) to generate the display-mapped SDR image (226). The display-mapped SDR image (226) can then be used, e.g., to generate the display-mapped signal (137) for the target display (140).

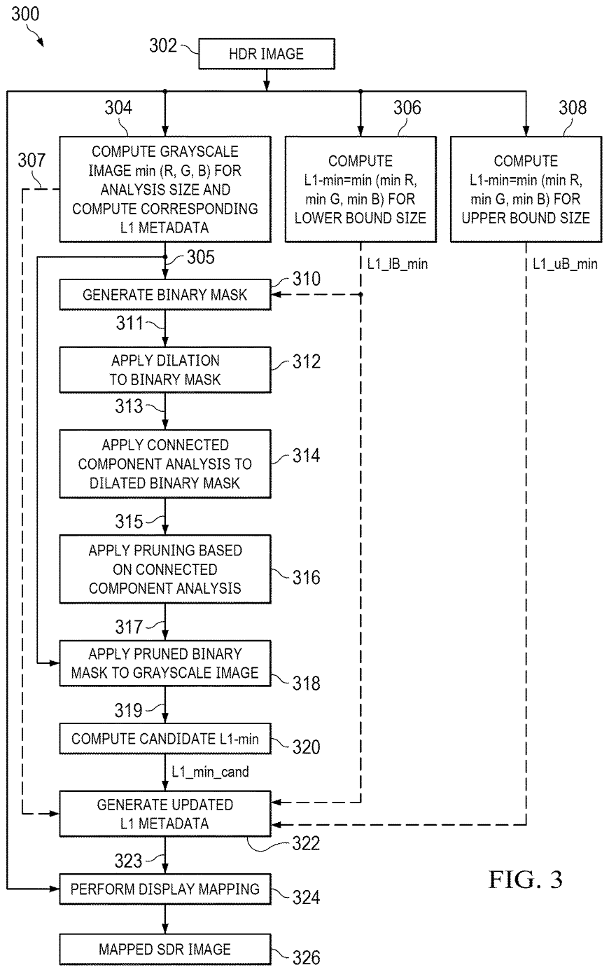

FIG. 3 is a flowchart illustrating a display-mapping method (300) according to some additional embodiments. In operation, the method (300) is used to perform a more-optimal selection of L1-min and then generate a display-mapped SDR image (326) based on an input HDR image (302) and the updated L1 metadata. The display-mapped SDR image (326) can be used, e.g., to generate the display-mapped signal (137) for the target display (140).

The workflow of the display-mapping method (300) is generally similar to the workflow of the display-mapping method (200), except that the latter is primarily directed at selecting a more-optimal L1-max value whereas the former is primarily directed at selecting a more-optimal L1-min value. For different HDR images, either one of the methods (200, 300) can typically be selected based on the overall characteristics of the image and further based on identification of the details thereof that are deemed “more important” with respect to the creative intent. In the below description of the display-mapping method (300), emphasis is given to differences between the methods (200, 300). For some of the features of the method (300) that are, mutatis mutandis, analogous to the corresponding features of the method (200), the description of the method (300) refers to the above description of the method (200).

In various examples, the method (300) relies on the same set of configuration parameters as the method (200). The kernel sizes for the filtering operations of filtering blocks (304, 306, 308) are determined based on Eqs. (1), (2), and (3), respectively. The filtering block (304) also includes converting the filtered RGB color image into a corresponding grayscale image (305) by determining, for each pixel, the value of min(R, G, B) and assigning the determined value to the corresponding pixel of the grayscale image (305). The filtering block (304) also includes computing the L1-max, L1-mid, and L1-min values (307) for the filtered RGB color image and/or the grayscale image (305). The filtering block (306) includes computing the L1-min value for the lower bound filtered image. The filtering block (308) similarly includes computing the L1-min value for the upper bound filtered image. For each of the blocks (304, 306, 308), the computation of L1-min is performed using Eq. (9):

$$L 1 min = min ( min R , min G , min B ) \qquad ( 9 )$$

Hereafter, the L1-min value computed in the block (306) is denoted as L1_lb_min, and the L1-min value computed in the block (308) is denoted as L1_ub_min. The L1-max, L1-mid, and L1-min values for the filtered RGB color image are denoted as L1_analysis_max, L1_analysis_mid, and L1_analysis_min, respectively.

Operations of a next block (310) of the method (300) include converting the grayscale image (305) generated in the block (304) into a corresponding binary mask (311) based on the value of L1_lb_min computed in the block (306). More specifically, each pixel of the binary mask (306) can only have a value of 0 or 1. The pixel value in the binary mask (311) is “1” when the corresponding pixel in the grayscale image (305) has a value that is equal to or smaller than L1_lb_min. The pixel value in the binary mask (311) is “0” when the corresponding pixel in the grayscale image (305) has a value that is greater than L1_lb_min.

Operations of the blocks (312, 314, 316, 318) of the method (300) are analogous to the operations of the blocks (212, 214, 216, 218), respectively, of the method (200). The input to the block (312) is the binary mask (311). The output of the block (312) is a dilated binary mask (313). The output of the block (314) is a labeled binary mask (315), wherein different labels identify different distinct subsets determined using the above-indicated CCL and CCA processes. One characteristic of each distinct subset in the labeled binary mask (315) is a subset size, e.g., defined as the number of pixels in the subset. Depending on the input HDR image (302), the topologies of different distinct subsets in the labeled binary mask (315) may vary. The distinct subsets whose size is smaller than the pruning threshold are removed from the labeled binary mask (315) in the pruning block (316) to produce a corresponding pruned binary mask (317). An output of the block (318) is a masked grayscale image (319) generated by pixelwise multiplication of the grayscale image (305) and the pruned binary mask (317).

A block (320) of the method (300) includes computing a candidate L1-min value based on the masked greyscale image (319). Hereafter, the computed candidate L1-min value is denoted as L1_min_cand. In a representative example, the value of L_min_cand is computed as follows: L1 min_cand=min(median{P};) (10)

$$L1min\_cand = {min}_{j} ( median {\{ P \}}_{j} ) \qquad ( 10 )$$

where j is the index used to label different subsets of the pruned binary mask (317); and {P}j denotes the set of pixel values in the masked greyscale image (319) corresponding to the j-th subset. In other words, computations in accordance with Eq. (10) include finding a median pixel value for each of the subsets in the masked greyscale image (319) and then finding a minimum value among those median pixel values.

The method (300) further includes generating an updated set (323) of L1 metadata in a block (322). Herein, the updated L1-max, L1-mid, and L1-min values are denoted as LL_max_upd, L1_mid_upd, and L1_min_upd, respectively, and are determined as follows:

$$L1\_min \_upd = clamp ( L1\_lb \_min , L1\_min \_cand , L1\_ub \_min ) \qquad ( 11 )$$

$$L1\_mid \_upd = L1\_analysis \_mid \qquad ( 12 )$$

$$L1\_max \_upd = L1\_analysis \_max \qquad ( 13 )$$

The display-mapped SDR image (326) is generated in a display mapping block (324) of the method (300). Operations of the display mapping block (324) include applying the updated set (323) of L1 metadata to the input HDR image (302) to generate the display-mapped SDR image (326). The display-mapped SDR image (326) can then be used, e.g., to generate the display-mapped signal (137) for the target display (140).

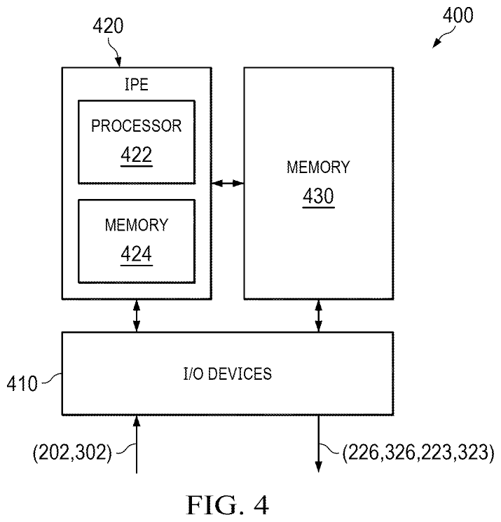

FIG. 4 is a block diagram illustrating a computing device (400) according to various examples. The device (400) can be used, e.g., to implement the process flow (100). The device (400) comprises input/output (I/O) devices (410), an image-processing engine (IPE, 420), and a memory (430). The I/O devices (410) may be used to enable the device (400) to receive the input HDR images (202, 302) and the configuration/control inputs and to output the SDR images (226, 326) and the metadata (223, 323). The I/O devices (410) may also be used to connect the device (400) to a display.

The memory (430) may have buffers to receive image data and other pertinent input data. The data may be, e.g., in the form of image files, data packets, and XML files. Once the data are received, the memory (430) may provide parts of the data to the IPE (420), e.g., for executing the methods (200, 300). The IPE (420) includes a processor (422) and a memory (424). The memory (424) may store therein program code, which when executed by the processor (422) enables the IPE (420) to perform image processing, including but not limited to the image processing in accordance with some the process flow (100) and the methods (200, 300). Once the IPE (420) generates the image (140) and the metadata (150) by executing the corresponding portions of the code, the IPE (420) operates to output the same. The IPE (420) may perform rendering processing of the various images and provide the corresponding viewable image(s) for being viewed on the display. The viewable image can be, e.g., in the form of a suitable image file outputted through the I/O devices (410).

According to an example embodiment disclosed above, e.g., in the summary section and/or in reference to any one or any combination of some or all of FIGS. 1-4, provided is an image-processing apparatus for estimating metadata, the apparatus comprising: at least one processor; and at least one memory including program code, wherein the at least one memory and the program code are configured to, with the at least one processor, cause the apparatus at least to: generate a grayscale image via first filtering applied to an input color image having a first dynamic range (DR), the first filtering being performed with a first kernel; generate a first binary mask (e.g., 213, FIG. 2; 313, FIG. 3) based on intensity thresholding applied to the grayscale image; generate a second binary mask (e.g., 217, FIG. 2; 317, FIG. 3) based on connected component analysis of the first binary mask; and generate a first set of L1 metadata based on a pixelwise product of the grayscale image and the second binary mask.

In some embodiments of the above apparatus, the at least one memory and the program code are further configured to, with the at least one processor, cause the apparatus to generate an output color image by display mapping the input color image with the first set of L1 metadata, the output color image having a second DR smaller than the first DR.

In some embodiments of any of the above apparatus, the at least one memory and the program code are further configured to, with the at least one processor, cause the apparatus to: generate a lower bound color image via second filtering applied to the input color image, the second filtering being performed with a second kernel; and compute a first bounding metadata value based on the lower bound color image, wherein the intensity thresholding is performed using the first bounding metadata value as a threshold value.

In some embodiments of any of the above apparatus, the at least one memory and the program code are further configured to, with the at least one processor, cause the apparatus to: generate an upper bound color image via third filtering applied to the input color image, the third filtering being performed with a third kernel; and compute a second bounding metadata value based on the upper bound color image, wherein the third kernel has a smaller size than the second kernel.

In some embodiments of any of the above apparatus, the first bounding metadata value and the second bounding metadata value are used to clamp a corresponding metadata value in the first set of L1 metadata.

In some embodiments of any of the above apparatus, the at least one memory and the program code are further configured to, with the at least one processor, cause the apparatus to generate a second set of L1 metadata, which corresponds to the grayscale image, wherein the first set of L1 metadata includes at least one value from the second set of L1 metadata.

According to another example embodiment disclosed above, e.g., in the summary section and/or in reference to any one or any combination of some or all of FIGS. 1-4, provided is a method of tuning metadata, the method comprising: generating a grayscale image via first filtering applied to an input color image having a first dynamic range (DR), the first filtering being performed with a first kernel; generating a first binary mask (e.g., 213, FIG. 2; 313, FIG. 3) based on intensity thresholding applied to the grayscale image; generating a second binary mask (e.g., 217, FIG. 2; 317, FIG. 3) based on connected component analysis of the first binary mask; and generating a first set of L1 metadata based on a pixelwise product of the grayscale image and the second binary mask.

In some embodiments of the above method, the method further comprises generating an output color image by display mapping the input color image with the first set of L1 metadata, the output color image having a second DR smaller than the first DR.

In some embodiments of any of the above methods, the first DR is a high DR; and wherein the second DR is a standard DR.

In some embodiments of any of the above methods, the method further comprises: generating a lower bound color image via second filtering applied to the input color image, the second filtering being performed with a second kernel; and computing a first bounding metadata value based on the lower bound color image, wherein the intensity thresholding is performed using the first bounding metadata value as a threshold value.

In some embodiments of any of the above methods, the first bounding metadata value is an L1-max metadata value or an L1-min metadata value corresponding to the lower bound color image.

In some embodiments of any of the above methods, the method further comprises: generating an upper bound color image via third filtering applied to the input color image, the third filtering being performed with a third kernel; and computing a second bounding metadata value based on the upper bound color image, wherein the third kernel has a smaller size than the second kernel.

In some embodiments of any of the above methods, the second bounding metadata value is an L1-max metadata value or an L1-min metadata value corresponding to the upper bound color image.

In some embodiments of any of the above methods, the first kernel has a smaller size than the third kernel.

In some embodiments of any of the above methods, the first bounding metadata value and the second bounding metadata value are used to clamp a corresponding metadata value in the first set of L1 metadata.

In some embodiments of any of the above methods, the method further comprises generating a second set of L1 metadata, which corresponds to the grayscale image, wherein the first set of L1 metadata includes at least one value from the second set of L1 metadata.

In some embodiments of any of the above methods, said generating the first binary mask comprises: generating a third binary mask (e.g., 211, FIG. 2; 311, FIG. 3) by applying the intensity thresholding to the grayscale image; and dilating the third binary mask to generate the first binary mask.

In some embodiments of any of the above methods, said generating the second binary mask comprises: applying the connected component analysis to identify a plurality of distinct subsets of components in the first binary mask; comparing a respective size of each individual one of the distinct subsets with a pruning size; and removing from the first binary mask each of the distinct subsets for which the respective size is smaller than the pruning size to generate the second binary mask.

In some embodiments of any of the above methods, said generating the first set of L1 metadata comprises: compiling a set of one or more median pixel values by including therein a respective median pixel value of each distinct subset of components of the pixelwise product; and determining an L1-max metadata value or an L1-min metadata value for the first set of L1 metadata by finding a maximum value or a minimum value, respectively, in the set of the one or more median pixel values.

According to yet another example embodiment disclosed above, e.g., in the summary section and/or in reference to any one or any combination of some or all of FIGS. 1-4, provided is a non-transitory computer-readable medium storing instructions that, when executed by an electronic processor, cause the electronic processor to perform operations comprising the any one of the above methods.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

Various aspects of the present disclosure may be appreciated from the following Enumerated Example Embodiments (EEEs):
EEE 1. A method of tuning metadata, the method comprising:
   generating a grayscale image via first filtering applied to an input color image having a first dynamic range (DR), the first filtering being performed with a first kernel;
   generating a first binary mask based on intensity thresholding applied to the grayscale image;
   generating a second binary mask based on connected component analysis of the first binary mask; and
   generating a first set of L1 metadata based on a pixelwise product of the grayscale image and the second binary mask.
EEE 2. The method of EEE 1, further comprising generating an output color image by display mapping the input color image with the first set of L1 metadata, the output color image having a second DR smaller than the first DR.
EEE 3. The method of EEE 1 or EEE 2, further comprising:
   generating a lower bound color image via second filtering applied to the input color image, the second filtering being performed with a second kernel; and
   computing a first bounding metadata value based on the lower bound color image,
   wherein the intensity thresholding is performed using the first bounding metadata value as a threshold value.
EEE 4. The method of EEE 3, further comprising:
   generating an upper bound color image via third filtering applied to the input color image, the third filtering being performed with a third kernel; and
   computing a second bounding metadata value based on the upper bound color image,
   wherein the third kernel has a smaller size than the second kernel.
EEE 5. The method of EEE 4,
   wherein the first bounding metadata value is an L1-max metadata value or an L1-min metadata value corresponding to the lower bound color image; and
   wherein the second bounding metadata value is an L1-max metadata value or an L1-min metadata value corresponding to the upper bound color image.
EEE 6. The method of any one of the preceding claims, further comprising generating a second set of L1 metadata, which corresponds to the grayscale image,
   wherein the first set of L1 metadata includes at least one value from the second set of L1 metadata.
EEE 7. The method of any one of the preceding claims, wherein said generating the first binary mask comprises:
   generating a third binary mask by applying the intensity thresholding to the grayscale image; and
   dilating the third binary mask to generate the first binary mask.
EEE 8. The method of EEE 7, wherein said generating the second binary mask comprises:
   applying the connected component analysis to identify a plurality of distinct subsets of components in the first binary mask;
   comparing a respective size of each individual one of the distinct subsets with a pruning size; and
   removing from the first binary mask each of the distinct subsets for which the respective size is smaller than the pruning size to generate the second binary mask.
EEE 9. The method of EEE 8, wherein said generating the first set of L1 metadata comprises:
   compiling a set of one or more median pixel values by including therein a respective median pixel value of each distinct subset of components of the pixelwise product; and
   determining an L1-max metadata value or an L1-min metadata value for the first set of L1 metadata by finding a maximum value or a minimum value, respectively, in the set of the one or more median pixel values.
EEE 10. An image-processing apparatus for estimating metadata, the apparatus comprising:
   at least one processor; and
   at least one memory including program code;
wherein the at least one memory and the program code are configured to, with the at least one processor, cause the apparatus at least to:
   generate a grayscale image via first filtering applied to an input color image having a first dynamic range (DR), the first filtering being performed with a first kernel;
   generate a first binary mask based on intensity thresholding applied to the grayscale image;
   generate a second binary mask based on connected component analysis of the first binary mask; and
   generate a first set of L1 metadata based on a pixelwise product of the grayscale image and the second binary mask.
EEE 11. The apparatus of EEE 10, wherein the at least one memory and the program code are further configured to, with the at least one processor, cause the apparatus to generate an output color image by display mapping the input color image with the first set of L1 metadata, the output color image having a second DR smaller than the first DR.
EEE 12. The apparatus of EEE 10 or EEE 11, wherein the at least one memory and the program code are further configured to, with the at least one processor, cause the apparatus to:
   generate a lower bound color image via second filtering applied to the input color image, the second filtering being performed with a second kernel; and
   compute a first bounding metadata value based on the lower bound color image,
   wherein the intensity thresholding is performed using the first bounding metadata value as a threshold value.
EEE 13. The apparatus of EEE 12, wherein the at least one memory and the program code are further configured to, with the at least one processor, cause the apparatus to:
   generate an upper bound color image via third filtering applied to the input color image, the third filtering being performed with a third kernel; and
   compute a second bounding metadata value based on the upper bound color image,
   wherein the third kernel has a smaller size than the second kernel.
EEE 14. The apparatus of EEE 13, wherein the first bounding metadata value and the second bounding metadata value are used to clamp a corresponding metadata value in the first set of L1 metadata.
EEE 15. The apparatus of any one of EEEs 10 to 14, wherein the at least one memory and the program code are further configured to, with the at least one processor, cause the apparatus to generate a second set of L1 metadata, which corresponds to the grayscale image,
   wherein the first set of L1 metadata includes at least one value from the second set of L1 metadata.

1. A method of tuning metadata, the method comprising:
generating a grayscale image via first filtering applied to an input color image having a first dynamic range (DR), the first filtering being performed with a first kernel;
generating a first binary mask based on intensity thresholding applied to the grayscale image;
generating a second binary mask based on connected component analysis of the first binary mask; and
generating a first set of L1 metadata based on a pixelwise product of the grayscale image and the second binary mask.

2. The method of claim 1, further comprising generating an output color image by display mapping the input color image with the first set of L1 metadata, the output color image having a second DR smaller than the first DR.

3. The method of claim 1, further comprising:
generating a lower bound color image via second filtering applied to the input color image, the second filtering being performed with a second kernel; and
computing a first bounding metadata value based on the lower bound color image,
wherein the intensity thresholding is performed using the first bounding metadata value as a threshold value.

4. The method of claim 3, further comprising:
generating an upper bound color image via third filtering applied to the input color image, the third filtering being performed with a third kernel; and
computing a second bounding metadata value based on the upper bound color image,
wherein the third kernel has a smaller size than the second kernel.

5. The method of claim 4,
wherein the first bounding metadata value is an L1-max metadata value or an L1-min metadata value corresponding to the lower bound color image; and
wherein the second bounding metadata value is an L1-max metadata value or an L1-min metadata value corresponding to the upper bound color image.

6. The method of claim 1, further comprising generating a second set of L1 metadata, which corresponds to the grayscale image,
wherein the first set of L1 metadata includes at least one value from the second set of L1 metadata.

7. The method of claim 1, wherein said generating the first binary mask comprises:
generating a third binary mask by applying the intensity thresholding to the grayscale image; and
dilating the third binary mask to generate the first binary mask.

8. The method of claim 7, wherein said generating the second binary mask comprises:
applying the connected component analysis to identify a plurality of distinct subsets of components in the first binary mask;
comparing a respective size of each individual one of the distinct subsets with a pruning size; and
removing from the first binary mask each of the distinct subsets for which the respective size is smaller than the pruning size to generate the second binary mask.

9. The method of claim 8, wherein said generating the first set of L1 metadata comprises:
compiling a set of one or more median pixel values by including therein a respective median pixel value of each distinct subset of components of the pixelwise product; and
determining an L1-max metadata value or an L1-min metadata value for the first set of L1 metadata by finding a maximum value or a minimum value, respectively, in the set of the one or more median pixel values.

10. An image-processing apparatus for estimating metadata, the apparatus comprising:
at least one processor; and
at least one memory including program code;
wherein the at least one memory and the program code are configured to, with the at least one processor, cause the apparatus at least to:
generate a grayscale image via first filtering applied to an input color image having a first dynamic range (DR), the first filtering being performed with a first kernel;
generate a first binary mask based on intensity thresholding applied to the grayscale image;
generate a second binary mask based on connected component analysis of the first binary mask; and
generate a first set of L1 metadata based on a pixelwise product of the grayscale image and the second binary mask.

11. The apparatus of claim 10, wherein the at least one memory and the program code are further configured to, with the at least one processor, cause the apparatus to generate an output color image by display mapping the input color image with the first set of L1 metadata, the output color image having a second DR smaller than the first DR.

12. The apparatus of claim 10, wherein the at least one memory and the program code are further configured to, with the at least one processor, cause the apparatus to:
generate a lower bound color image via second filtering applied to the input color image, the second filtering being performed with a second kernel; and
compute a first bounding metadata value based on the lower bound color image,
wherein the intensity thresholding is performed using the first bounding metadata value as a threshold value.

13. The apparatus of claim 12, wherein the at least one memory and the program code are further configured to, with the at least one processor, cause the apparatus to:
generate an upper bound color image via third filtering applied to the input color image, the third filtering being performed with a third kernel; and
compute a second bounding metadata value based on the upper bound color image,
wherein the third kernel has a smaller size than the second kernel.

14. The apparatus of claim 13, wherein the first bounding metadata value and the second bounding metadata value are used to clamp a corresponding metadata value in the first set of L1 metadata.

15. The apparatus of claim 10, wherein the at least one memory and the program code are further configured to, with the at least one processor, cause the apparatus to generate a second set of L1 metadata, which corresponds to the grayscale image,
wherein the first set of L1 metadata includes at least one value from the second set of L1 metadata.
